(19) United States
(12) Patent Application Publication
(10) Pub. No.: US 2021/0197670 A1
(43) Pub. Date: Jul. 1, 2021

(54) INSTRUMENT PANEL STRUCTURE

(71) Applicant: TOYOTA JIDOSHA KABUSHIKI KAISHA, Aichi-ken (JP)

(72) Inventor: Hideyuki SAKURAI, Toyota-shi (JP)

(21) Appl. No.: 17/037,693

(22) Filed: Sep. 30, 2020

(30) Foreign Application Priority Data
Dec. 27, 2019 (JP) 2019-238446

(51) Int. Cl. B60K 37/02

(52) U.S. Cl. CPC B60K 37/02

(57) ABSTRACT

An instrument panel structure of the present disclosure includes: an instrument-panel body portion constituting a body portion of an instrument panel of a vehicle and placed in front of a wheel in the vehicle front-rear direction; and one or more spacers configured to be placeable selectively on a first side or a second side in the vehicle width direction relative to the instrument-panel body portion, the one or more spacers constituting part of the instrument panel.

### CROSS-REFERENCE TO RELATED APPLICATION

This application claims priority to Japanese Patent Application No. 2019-238446 filed on Dec. 27, 2019, incorporated herein by reference in its entirety.

### BACKGROUND

### 1. Technical Field

The present disclosure relates to an instrument panel structure for a vehicle.

### 2. Description of Related Art

A dashboard (instrument panel) for a vehicle, described in Japanese Unexamined Patent Application Publication No. 9-240316 (JP 9-240316 A), is formed symmetrically in the right-left direction so that the dashboard can be commonized for both a left-hand drive specification and a right-hand drive specification of the same vehicle type. Respective recessed portions are formed on the left side of an upper part of the instrument panel and on the right side of the upper part of the instrument panel so that a gauge board or decorative cover formed separately can be selectively attached to the recessed portions. Further, respective notch portions are formed on the left side of a lower part of the instrument panel and on the right side of the lower part of the instrument panel so that a wheel column or glove compartment formed separately can be selectively attached to the notch portions.

### SUMMARY

In the meantime, as means to reduce a manufacturing cost by employing one type of component for an instrument panel, there is a method of setting a wheel position in the center of a vehicle in the width direction. However, some countries have a regulation that does not permit traveling of a vehicle if the vehicle does not have a wheel on the left side relative to the center of the vehicle in the width direction. In this respect, in the above technique in the related art, only either of the left-hand drive specification and the right-hand drive specification can be selected, and therefore, there is room for improvement from the viewpoint of improving a degree of freedom in setting of the wheel position.

The present disclosure is achieved in consideration of the above fact, and an object of the present disclosure is to provide an instrument panel structure that can commonize a component and can improve a degree of freedom in setting of a wheel position.

An instrument panel structure according to a first aspect of the present disclosure includes an instrument-panel body portion and one or more spacers. The instrument-panel body portion constitutes a body portion of an instrument panel of a vehicle and placed in front of a wheel in the vehicle front-rear direction. The one or more spacers are configured to be placeable selectively on a first side or a second side in the vehicle width direction relative to the instrument-panel body portion, the one or more spacers constituting part of the instrument panel.

In the disclosure according to the first aspect, the instrument-panel body portion constituting the body portion of the instrument panel of the vehicle is placed in front of the wheel in the vehicle front-rear direction. Then, the one or more spacers constituting part of the instrument panel are placed selectively on the first side or the second side in the vehicle width direction relative to the instrument-panel body portion. By this selection, the positions of the instrument-panel body portion and the wheel in the vehicle width direction can be changed, so that components of the instrument panel can be commonized for vehicles of specifications with different wheel positions. Besides, by changing the dimensions of the instrument-panel body portion and the spacer in the vehicle width direction, the number of spacers, and so on, for example, the setting of the wheel position can be changed, thereby making it possible to improve the degree of freedom in setting of the wheel position.

An instrument panel structure according to a second aspect of the present disclosure may be configured as follows. That is, in the instrument panel structure according to the first aspect, only one spacer may be provided.

In the disclosure according to the second aspect, only one spacer is provided, so that the following two states can be taken: a state where the spacer is placed on the first side in the vehicle width direction relative to the instrument-panel body portion; and a state where the spacer is placed on the second side in the vehicle width direction relative to the instrument-panel body portion.

An instrument panel structure according to a third aspect of the present disclosure may be configured as follows. That is, in the instrument panel structure according to the second aspect, in a state where the spacer is placed on the first side in the vehicle width direction relative to the instrument-panel body portion, the wheel may be placed in a center in the vehicle width direction, and in a state where the spacer is placed on the second side in the vehicle width direction relative to the instrument-panel body portion, the wheel may be placed by being displaced to the first side in the vehicle width direction from the center in the vehicle width direction.

In the disclosure according to the third aspect, a state where the wheel is placed in the center in the vehicle width direction and a state where the wheel is placed by being displaced to the first side in the vehicle width direction (e.g., the left side in the vehicle width direction) from the center in the vehicle width direction can be taken. Hereby, components can be commonized for two specifications, i.e., a specification in which the wheel position is set in the center in the vehicle width direction and a left-hand drive specification, for example.

An instrument panel structure according to a fourth aspect of the present disclosure may be configured as follows. That is, in the instrument panel structure according to the first aspect, two spacers may be provided.

In the disclosure according to the fourth aspect, two spacers are provided, so that the following three states can be taken: a state where the spacers are placed respectively on the first side and on the second side in the vehicle width direction relative to the instrument-panel body portion; a state where the two spacers are placed on the first side in the vehicle width direction relative to the instrument-panel body portion; and a state where the two spacers are placed on the second side in the vehicle width direction relative to the instrument-panel body portion.

An instrument panel structure according to a fifth aspect of the present disclosure may be configured as follows. That is, in the instrument panel structure according to the fourth aspect, in a state where the two spacers are separately placed on the first side and on the second side in the vehicle width direction relative to the instrument-panel body portion, the wheel may be placed in a center in the vehicle width direction; and in a state where the two spacers are placed on either one of the first side and the second side in the vehicle width direction relative to the instrument-panel body portion, the wheel may be placed by being displaced to the other one of the first side and the second side from the center in the vehicle width direction.

In the disclosure according to the fifth aspect, the following states can be taken: a state where the wheel is placed in the center in the vehicle width direction; a state where the wheel is placed by being displaced to the first side in the vehicle width direction (e.g., the left side in the vehicle width direction) from the center in the vehicle width direction; and a state where the wheel is placed by being displaced to the second side in the vehicle width direction (e.g., the right side in the vehicle width direction) from the center in the vehicle width direction. Hereby, components can be commonized for three specifications, i.e., the specification in which the wheel position is set in the center in the vehicle width direction, the left-hand drive specification, and the right-hand drive specification.

An instrument panel structure according to a sixth aspect of the present disclosure may be configured as follows. That is, the instrument panel structure according to any one of the first to fifth aspects may further include an instrument-panel under-window portion provided with a defroster air outlet, the instrument-panel under-window portion being adjacently placed in front of the instrument-panel body portion and the spacer in the vehicle front-rear direction.

In the disclosure according to the sixth aspect, the instrument-panel under-window portion provided with the defroster air outlet is adjacently placed in front of the instrument-panel body portion and the spacer in the vehicle front-rear direction. The instrument-panel under-window portion can be commonized regardless of the specification of the wheel position (that is, selection of a layout for the spacer). As a result, the defroster air outlet formed in the instrument-panel under-window portion can be commonized, so that it takes less time to develop performance of a defroster.

An instrument panel structure according to a seventh aspect of the present disclosure may be configured as follows. That is, the instrument panel structure according to any one of the first to sixth aspects may further include a pair of right and left instrument-panel side portions provided such that the right and left instrument-panel side portions are placed in opposite side portions of a vehicle cabin in the vehicle width direction, and the instrument-panel body portion and the spacer may be placed between the instrument-panel side portions.

In the disclosure according to the seventh aspect, the instrument-panel body portion and the spacer are placed between the right and left instrument-panel side portions placed in the opposite side portions, in the vehicle width direction, of the vehicle cabin. The right and left instrument-panel side portions can be commonized for specifications with different wheel positions.

An instrument panel structure according to an eighth aspect of the present disclosure may be configured as follows. That is, in the instrument panel structure according to any one of the first to seventh aspects, a downhill step directed toward a surface side of the spacer may be formed between a surface of the instrument-panel body portion and a surface of the spacer.

In the disclosure according to the eighth aspect, the downhill step directed toward the surface side of the spacer is formed between the surface of the instrument-panel body portion and the surface of the spacer, the instrument-panel body portion being placed in front of the wheel in the vehicle front-rear direction. Hereby, a boundary between the surface of the instrument-panel body portion and the surface of the spacer is hardly observed from a driver who operates the wheel. Hereby, the outward appearance of the instrument panel seen from the driver can be improved.

An instrument panel structure according to a ninth aspect of the present disclosure may be configured as follows. That is, in the instrument panel structure according to the sixth aspect or according to the seventh or eighth aspect dependent on the sixth aspect, a downhill step directed toward a surface side of the instrument-panel under-window portion may be formed between a surface of the instrument-panel body portion and a surface of the instrument-panel under-window portion.

In the disclosure according to the ninth aspect, the downhill step directed toward the surface side of the instrument-panel under-window portion is formed between the surface of the instrument-panel body portion and the surface of the instrument-panel under-window portion, the instrument-panel body portion being placed in front of the wheel in the vehicle front-rear direction. Hereby, a boundary between the surface of the instrument-panel body portion and the surface of the instrument-panel under-window portion is hardly observed from the driver who operates the wheel, so that the outward appearance of the instrument panel seen from the driver can be improved.

An instrument panel structure according to a tenth aspect of the present disclosure may be configured as follows. That is, in the instrument panel structure according to the seventh aspect or according to the eighth or ninth aspect dependent on the seventh aspect, a downhill step directed toward a surface side of the instrument-panel side portion may be formed between a surface of the instrument-panel side portion and a surface of the instrument-panel body portion or the spacer placed to be adjacent to the instrument-panel side portion.

In the disclosure according to the tenth aspect, the downhill step directed toward the surface side of the instrument-panel side portion is formed between the surface of the instrument-panel side portion and the surface of the instrument-panel body portion or the spacer placed to be adjacent to the instrument-panel side portion. Hereby, a boundary between the surface of the instrument-panel body portion or the spacer and the surface of the instrument-panel side portion is hardly observed from the driver who operates the wheel, so that the outward appearance of the instrument panel seen from the driver can be improved.

As described above, in the instrument panel structure of the present disclosure, components can be commonized, and the degree of freedom in setting of the wheel position can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view of a vehicle including an instrument panel formed by applying an instrument panel structure according to a first embodiment;

FIG. 2 is a plan view of the instrument panel according to the first embodiment and illustrates a state where a wheel is placed in the center in the vehicle width direction;

FIG. 3 is a plan view corresponding to FIG. 2 and illustrates a state where the wheel is placed by being displaced to the left side in the vehicle width direction from the center in the vehicle width direction;

FIG. 4 is a plan view illustrating an instrument panel formed by applying an instrument panel structure according to a second embodiment and illustrates a state where a wheel is placed in the center in the vehicle width direction;

FIG. 5 is a plan view corresponding to FIG. 4 and illustrates a state where the wheel is placed by being displaced to the left side in the vehicle width direction from the center in the vehicle width direction;

FIG. 6 is a plan view corresponding to FIG. 4 and illustrates a state where the wheel is placed by being displaced to the right side in the vehicle width direction from the center in the vehicle width direction;

FIG. 7 is a plan view illustrating an instrument panel formed by applying an instrument panel structure according to a third embodiment and illustrates a state where a wheel is placed in the center in the vehicle width direction;

FIG. 8 is a plan view illustrating an instrument panel formed by applying an instrument panel structure according to a fourth embodiment and illustrates a state where a wheel is placed in the center in the vehicle width direction;

FIG. 9 is a plan view illustrating an instrument panel formed by applying an instrument panel structure according to a fifth embodiment and illustrates a state where a wheel is placed by being displaced to the left side in the vehicle width direction from the center in the vehicle width direction;

FIG. 10 is a plan view corresponding to FIG. 9 and illustrates a state where the wheel is placed by being displaced to the right side in the vehicle width direction from the center in the vehicle width direction;

FIG. 11 is a plan view illustrating an instrument panel formed by applying an instrument panel structure according to a sixth embodiment and illustrates a state where a wheel is placed in the center in the vehicle width direction;

FIG. 12 is an enlarged sectional view illustrating a cut surface taken along a line F12-F12 in FIG. 11 in an enlarged manner; and

FIG. 13 is an enlarged sectional view illustrating a cut surface taken along a line F13-F13 in FIG. 11 in an enlarged manner.

### DETAILED DESCRIPTION OF EMBODIMENTS

### First Embodiment

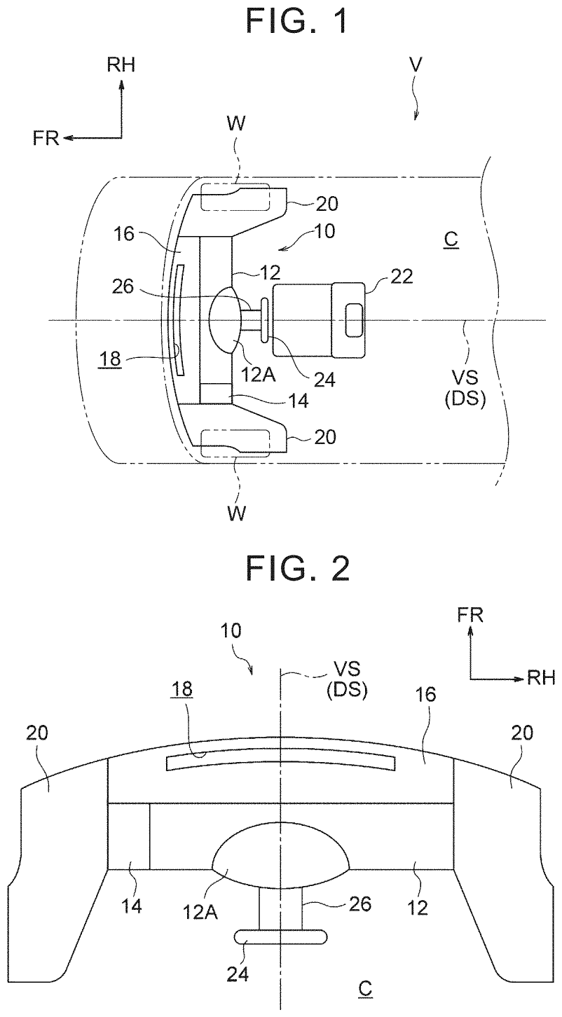

The following describes an instrument panel structure according to a first embodiment of the present disclosure with reference to FIGS. 1 to 3. Note that an arrow FR, an arrow RH, and an arrow UP shown appropriately in each figure indicate the front side (the advance side) in the vehicle front-rear direction, the right side in the vehicle width direction, and the upper side in the vehicle up-down direction, respectively. Hereinafter, in a case where a description is made by use of merely the front and rear sides, the right and left sides, and the upper and lower sides, they indicate the front and rear sides in the vehicle front-rear direction, the right and left sides in the vehicle right-left direction (the vehicle width direction), and the upper and lower sides in the vehicle up-down direction, respectively, unless otherwise specified.

Configuration

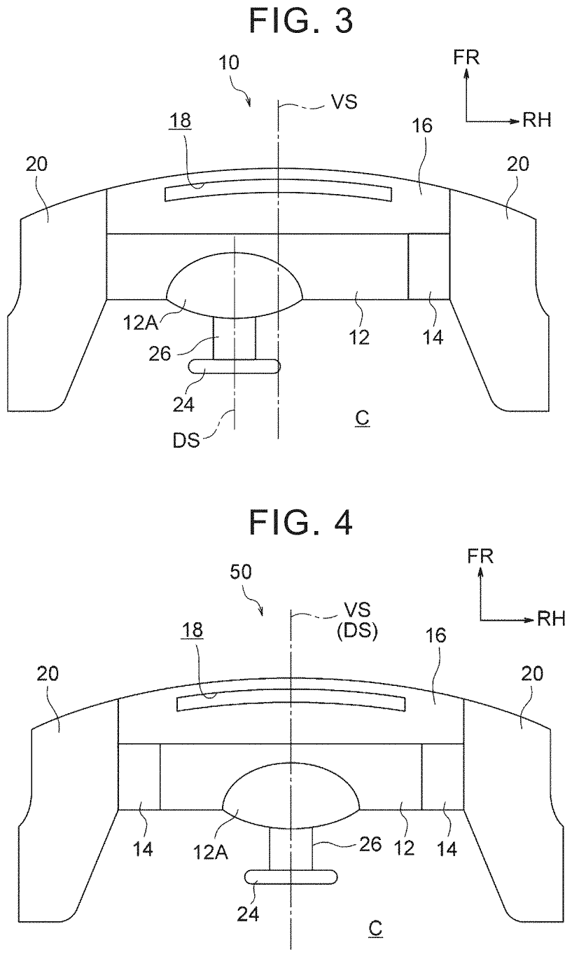

As illustrated in FIG. 1, a vehicle V according to a first embodiment of the present disclosure includes an instrument panel 10 disposed in a front end part inside a vehicle cabin C. In the vehicle V, a driver seat 22 is placed in a front part in the vehicle cabin C. The instrument panel 10 of the vehicle V is configured such that a component is commonized for a center-hand drive specification illustrated in FIGS. 1, 2 and for a left-hand drive specification illustrated in FIG. 3.

In the center-hand drive specification, a wheel (steering wheel) 24 is placed in a center VS in the vehicle width direction, and in the left-hand drive specification, the wheel 24 is placed by being displaced to the left side in the vehicle width direction from the center VS in the vehicle width direction. Further, in the center-hand drive specification, a driver seat 22 is placed in the center VS in the vehicle width direction as illustrated in FIG. 1, and in the left-hand drive specification, the driver seat 22 is placed by being displaced to the left side in the vehicle width direction from the center VS in the vehicle width direction (not shown). Note that, in FIG. 1, W indicates a tire-wheel assembly of the vehicle V, and in FIGS. 1 to 3, an alternate long and short dash line DS indicates the center (a so-called driver center) of the driver seat 22 in the vehicle width direction.

As illustrated in FIGS. 1 to 3, the instrument panel 10 includes an instrument-panel body portion 12, a spacer 14, an instrument-panel under-window portion 16, and a pair of right and left instrument-panel side portions 20. The instrument panel 10 includes only one spacer 14. The instrument-panel body portion 12, the spacer 14, the instrument-panel under-window portion 16, and the right and left instrument-panel side portions 20 are made of resin, for example.

The instrument-panel body portion 12 constitutes a body portion of the instrument panel 10 and has an elongated shape where its longitudinal direction is along the vehicle width direction. A measuring instrument disposition portion 12A where instruments (not shown) are disposed is provided near a central part of the instrument-panel body portion 12 in the vehicle width direction. The measuring instrument disposition portion 12A is placed to be slightly displaced to a first side in the vehicle width direction (herein, the left side in the vehicle width direction) from the center of the instrument-panel body portion 12 in the vehicle width direction. Further, the measuring instrument disposition portion 12A is placed in front of the wheel 24 in the vehicle front-rear direction. That is, the measuring instrument disposition portion 12A and the wheel 24 are placed at the same position in the vehicle width direction. A wheel column (a steering column) 26 for supporting the wheel 24 passes below the measuring instrument disposition portion 12A in the vehicle up-down direction so as to extend forward in the vehicle front-rear direction.

The spacer 14 constitutes part of the instrument panel 10 and is placeable selectively on the first side or a second side in the vehicle width direction relative to the instrument-panel body portion 12. The spacer 14 is placed to be adjacent to the instrument-panel body portion 12 in the vehicle width direction. A top face (a surface) of the spacer 14 and a top face (a surface) of the instrument-panel body portion 12 are placed on the same plane or generally on the same plane, and a rear face (a surface) of the spacer 14 and a rear face (a surface) of the instrument-panel body portion 12 are placed on the same plane or generally on the same plane. That is, the spacer 14 is formed to provide an appearance integrated with the instrument-panel body portion 12.

The instrument-panel under-window portion 16 is adjacently placed in front of the instrument-panel body portion 12 and the spacer 14 in the vehicle front-rear direction, and the instrument-panel under-window portion 16 is placed near the rear side, in the vehicle front-rear direction, relative to a lower end part of a front windshield (not shown). The dimension, in the vehicle width direction, of the instrument-panel under-window portion 16 is set to be equal to a dimension obtained by adding the dimension, in the vehicle width direction, of the instrument-panel body portion 12 and the dimension, in the vehicle width direction, of the spacer 14. Further, a top face (a surface) of the instrument-panel under-window portion 16 and the top faces (the surfaces) of the instrument-panel body portion 12 and the spacer 14 are placed on the same plane or generally on the same plane. A defroster air outlet 18 is formed in the instrument-panel under-window portion 16. A defroster duct provided in a vehicle air-conditioning device (not shown) placed inside the instrument panel 10 is connected to the defroster air outlet 18. When the vehicle air-conditioning device is operated in a defroster mode, conditioned air is sent from the defroster air outlet 18 to the front windshield. Hereby, fogging on the front windshield can be removed.

The right and left instrument-panel side portions 20 are placed in opposite side portions, in the vehicle width direction, of the front end part of the vehicle cabin C, and the instrument-panel body portion 12, the spacer 14, and the instrument-panel under-window portion 16 are placed between the right and left instrument-panel side portions 20. The interval between the right and left instrument-panel side portions 20 is set to be equal to the dimension, in the vehicle width direction, of the instrument-panel under-window portion 16. The dimension, in the vehicle front-rear direction, of the right and left instrument-panel side portions 20 is set to be larger than those of the instrument-panel body portion 12, the spacer 14, and the instrument-panel under-window portion 16, so that the right and left instrument-panel side portions 20 are placed to project rearward in the vehicle front-rear direction from the instrument-panel body portion 12 and the spacer 14. Top faces (surfaces) of the right and left instrument-panel side portions 20 are placed on the same plane or generally on the same plane as respective top faces (surfaces) of the instrument-panel body portion 12, the spacer 14, and the instrument-panel under-window portion 16.

Respective front end parts of the instrument-panel under-window portion 16 and the right and left instrument-panel side portions 20 correspond to the shape of the lower end part of the front windshield and are formed in a curved shape projecting forward in the vehicle front-rear direction. Further, a rear face of the instrument-panel under-window portion 16 and respective front end parts of the instrument-panel body portion 12 and the spacer 14 are formed in a linear shape along the vehicle width direction. Further, in the present embodiment, as an example, respective rear end parts of the instrument-panel body portion 12 and the spacer 14 are formed in a linear shape along the vehicle width direction, and both end parts, in the vehicle width direction, of each of the instrument-panel body portion 12, the spacer 14, and the instrument-panel under-window portion 16 are formed in a linear shape along the vehicle front-rear direction.

The instrument-panel body portion 12, the spacer 14, the instrument-panel under-window portion 16, and the right and left instrument-panel side portions 20 are attached to a vehicle body via brackets (not shown), for example. In the present embodiment, as illustrated in FIG. 2, in a state where the spacer 14 is placed on the left side in the vehicle width direction relative to the instrument-panel body portion 12, the wheel 24 is placed in the center VS in the vehicle width direction. Further, as illustrated in FIG. 3, in a state where the spacer 14 is placed on the right side in the vehicle width direction relative to the instrument-panel body portion 12, the wheel 24 is placed by being displaced to the left side in the vehicle width direction from the center VS in the vehicle width direction. That is, in the present embodiment, the instrument-panel body portion 12 is moved parallel to the vehicle width direction in accordance with the specification of the wheel position, and the spacer 14 is fitted in a vacant space on a lateral side of the instrument-panel body portion 12. The spacer 14 is fitted (inserted) in a vacant space on a lateral side of the instrument-panel body portion 12 such that the spacer 14 is integrally continuous with the instrument-panel body portion 12 so as to constitute part of the instrument panel 10.

Operations and Effects

The following describes operations and effects of the present embodiment.

In the present embodiment, the instrument-panel body portion 12 constituting the body portion of the instrument panel 10 of the vehicle V is placed in front of the wheel 24 in the vehicle front-rear direction. One or more spacers 14 constituting part of the instrument panel 10 are placed selectively on the first side or the second side in the vehicle width direction relative to the instrument-panel body portion 12. By this selection, the positions of the instrument-panel body portion 12 and the wheel 24 in the vehicle width direction can be changed. Hereby, the components of the instrument panel 10 can be commonized for vehicles of specifications with different wheel positions. Besides, for example, by changing the dimensions of the instrument-panel body portion 12 and the spacer 14 in the vehicle width direction, the number of spacers 14, and so on, the setting of the wheel position can be changed, thereby making it possible to improve a degree of freedom in setting of the wheel position.

Further, in the present embodiment, since only one spacer 14 is provided, the following two states can be taken: a state where the spacer 14 is placed on the first side in the vehicle width direction relative to the instrument-panel body portion 12; and a state where the spacer 14 is placed on the second side in the vehicle width direction relative to the instrument-panel body portion 12. More specifically, a state (a state illustrated in FIG. 2) where the wheel 24 is placed in the center VS in the vehicle width direction and a state (a state illustrated in FIG. 3) where the wheel 24 is placed by being displaced to the left side in the vehicle width direction from the center VS in the vehicle width direction can be taken. Hereby, the components of the instrument panel 10 can be used in common for two specifications including the center-hand drive specification and the left-hand drive specification, that is, the specifications asymmetrical to each other in terms of the wheel position relative to the center VS in the vehicle width direction. Besides, since only one spacer 14 is used, it is possible to restrain an increase in the number of components.

Further, in the present embodiment, the instrument-panel under-window portion 16 provided with the defroster air outlet 18 is adjacently placed in front of the instrument-panel body portion 12 and the spacer 14 in the vehicle front-rear direction. The instrument-panel under-window portion 16 can be commonized regardless of the specification of the wheel position (that is, selection of a layout for the spacer 14). As a result, the defroster air outlet 18 formed in the instrument-panel under-window portion 16 can be commonized, so that it takes less time to develop performance of a defroster in the vehicle air-conditioning device. That is, in a configuration where the position of the defroster air outlet 18 changes when the specification of the wheel position changes, it is necessary to individually design a shape and so on of a defroster duct in accordance with the position of the defroster air outlet 18, and this takes time for development. However, the present embodiment can avoid this problem.

Further, in the present embodiment, the instrument-panel body portion 12 and the spacer 14 are placed between the right and left instrument-panel side portions 20 placed in the opposite side portions, in the vehicle width direction, of the vehicle cabin C. However, the right and left instrument-panel side portions 20 can be commonized for specifications with different wheel positions. That is, in the present embodiment, the instrument-panel body portion 12, the spacer 14, the instrument-panel under-window portion 16, and the right and left instrument-panel side portions 20 can be all commonized for specifications with different wheel positions. This makes it possible to reduce a manufacturing cost of a mold, and so on. Further, it is possible to manufacture instrument panels for specifications with different wheel positions in one manufacturing line. As a result, for example, it is possible to restrain an increase in manufacturing cost even in a case of small-quantity production.

Next will be described other embodiments of the present disclosure. Note that configurations and operations basically similar to configurations and operations of the first embodiment have the same reference sign as those used in the first embodiment, and their descriptions are omitted.

### Second Embodiment

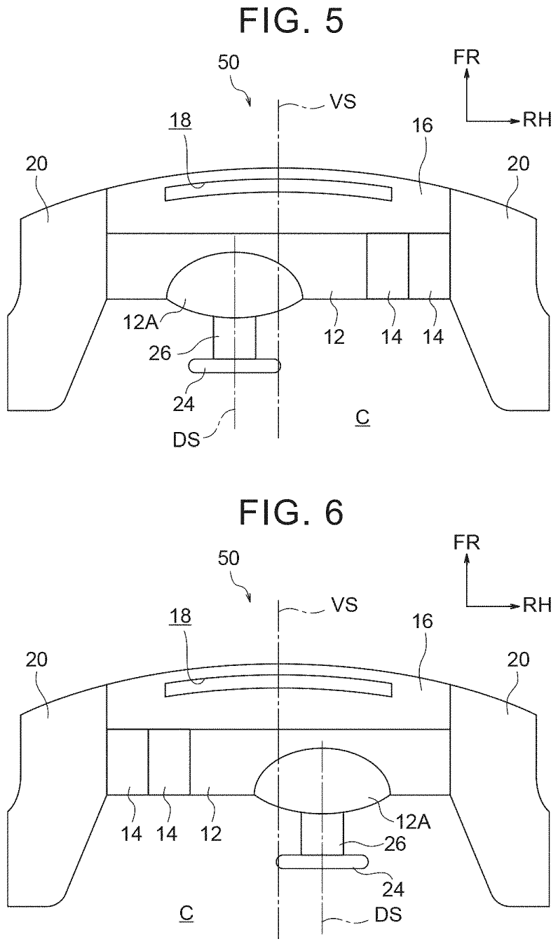

FIGS. 4 to 6 are plan views each illustrating an instrument panel 50 formed by applying an instrument panel structure according to a second embodiment of the present disclosure. The instrument panel 50 is different from the first embodiment in that the instrument panel 50 includes two spacers 14. The instrument panel 50 is configured such that components can be commonized for a center-hand drive specification illustrated in FIG. 4, a left-hand drive specification illustrated in FIG. 5, and a right-hand drive specification illustrated in FIG. 6.

In the center-hand drive specification, the two spacers 14 are separately placed on the opposite sides in the vehicle width direction relative to the instrument-panel body portion 12, and the wheel 24 is placed in the center VS in the vehicle width direction. Further, in the left-hand drive specification, the two spacers 14 are placed on the right side in the vehicle width direction relative to the instrument-panel body portion 12, and the wheel 24 is placed by being displaced to the left side in the vehicle width direction from the center VS in the vehicle width direction. Further, in the right-hand drive specification, the two spacers 14 are placed on the left side in the vehicle width direction relative to the instrument-panel body portion 12, and the wheel 24 is placed by being displaced to the right side from the center VS in the vehicle width direction. Note that, in each specification, the wheel 24 and the driver seat 22 (not shown) are placed at the same position in the vehicle width direction. This embodiment has a configuration similar to that of the first embodiment except the above configuration.

Similarly to the first embodiment, in the present embodiment, the components can be commonized, and the degree of freedom in setting of the wheel position can be improved. Besides, in the present embodiment, the two spacers 14 are provided, and the above three states can be taken. Accordingly, the components can be used in common for the three specifications, i.e., the center-hand drive specification, the left-hand drive specification, and the right-hand drive specification.

Note that, in the left-hand drive specification illustrated in FIG. 5 and the right-hand drive specification illustrated in FIG. 6, one spacer 14 having a magnitude equal to the magnitude of the two spacers 14 may be fitted in a space between the instrument-panel body portion 12 and the instrument-panel side portion 20.

### Third Embodiment

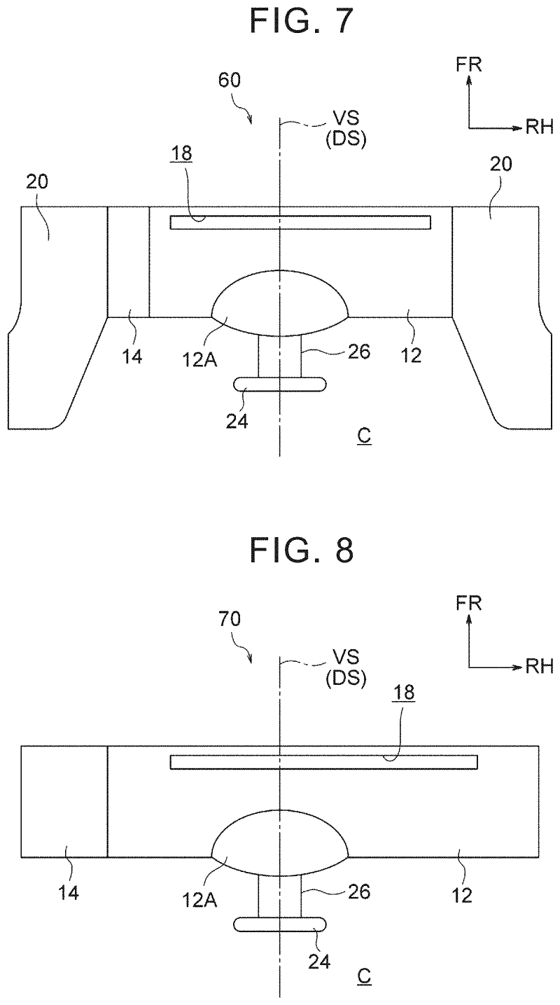

FIG. 7 is a plan view illustrating an instrument panel 60 formed by applying an instrument panel structure according to a third embodiment of the present disclosure. The instrument panel 60 is different from the first embodiment in that the instrument panel 60 does not include the instrument-panel under-window portion 16, and the defroster air outlet 18 is formed in the instrument-panel body portion 12. In the present embodiment, a lower end part of the front windshield (not shown) is formed in a linear shape along the vehicle width direction. Further, in the present embodiment, respective front end parts of the instrument-panel body portion 12, the spacer 14, and the right and left instrument-panel side portions 20 are formed in a linear shape along the vehicle width direction and are placed at the same position in the vehicle front-rear direction. This embodiment has a configuration similar to that of the first embodiment except the above configuration. Similarly to the first embodiment, in the present embodiment, the components can be commonized, and the degree of freedom in setting of the wheel position can be improved.

### Fourth Embodiment

FIG. 8 is a plan view illustrating an instrument panel 70 formed by applying an instrument panel structure according to a fourth embodiment of the present disclosure. The instrument panel 70 is different from the first embodiment in that the instrument panel 70 does not include the instrument-panel under-window portion 16 and the right and left instrument-panel side portions 20, and the defroster air outlet 18 is formed in the instrument-panel body portion 12. The instrument panel 70 is fitted between right and left A-pillars (not shown), for example, in the front end part of the vehicle cabin C. Similarly to the first embodiment, in the present embodiment, the components can be commonized, and the degree of freedom in setting of the wheel position can be improved.

### Fifth Embodiment

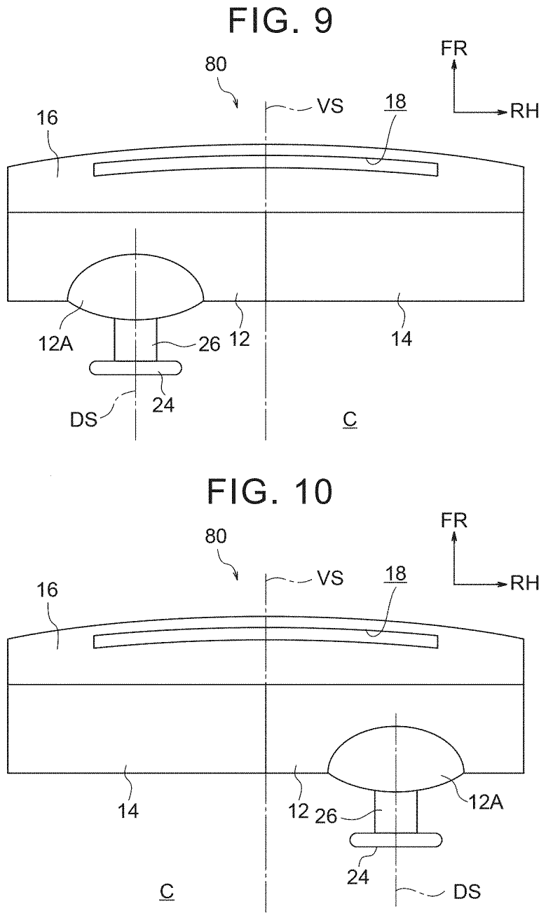

FIGS. 9, 10 are plan views each illustrating an instrument panel 80 formed by applying an instrument panel structure according to a fifth embodiment of the present disclosure. The instrument panel 80 is different from the first embodiment in that the instrument panel 80 does not include the right and left instrument-panel side portions 20, and the instrument-panel body portion 12 and the spacer 14 are set to have the same dimension in the vehicle width direction. In the present embodiment, components can be commonized for a left-hand drive specification illustrated in FIG. 9 and a right-hand drive specification illustrated in FIG. 10.

### Sixth Embodiment

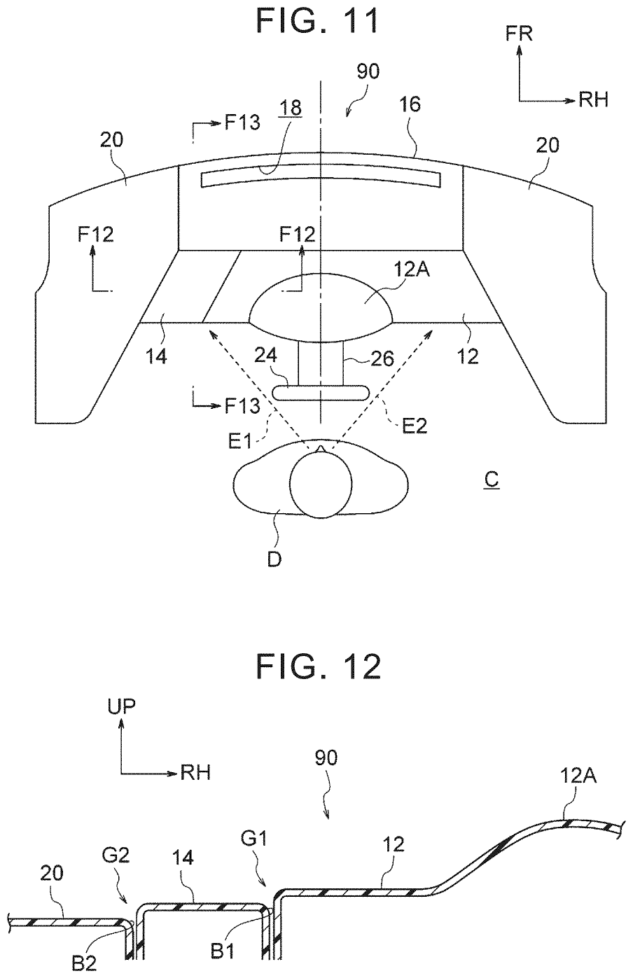

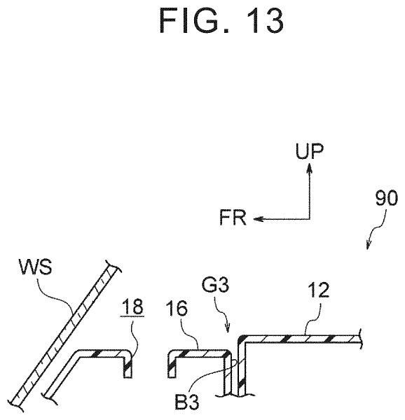

FIG. 11 is a plan view illustrating an instrument panel 90 formed by applying an instrument panel structure according to a sixth embodiment of the present disclosure. Further, FIG. 12 is a sectional view illustrating a cut surface along a line F12-F12 in FIG. 11 in an enlarged manner, and FIG. 13 is a sectional view illustrating a cut surface along a line F13-F13 in FIG. 11 in an enlarged manner. This embodiment basically has a configuration similar to that of the first embodiment, but side faces, in the vehicle width direction, of the instrument-panel body portion 12 and the spacer 14 incline toward the center VS side in the vehicle width direction as the side faces are directed forward in the vehicle front-rear direction. Further, inner side faces, in the vehicle width direction, of the right and left instrument-panel side portions 20, the side faces facing the instrument-panel body portion 12 and the spacer 14, incline toward the center VS side in the vehicle width direction as the inner side faces are directed forward in the vehicle front-rear direction. In the present embodiment, at the time when the spacer 14 is placed on the right side in the vehicle width direction relative to the instrument-panel body portion 12, the spacer 14 is rotated so that the shape of the spacer 14 is reversed in the right-left direction.

Further, in the present embodiment, as illustrated in FIG. 12, a downhill step G1 directed toward the top face side of the spacer 14 is formed between the top face (surface) of the instrument-panel body portion 12 and the top face (surface) of the spacer 14. Similarly, a downhill step G2 directed toward the top face side of the left instrument-panel side portion 20 is formed between the top face (surface) of the left instrument-panel side portion 20 and the top face (surface) of the spacer 14 placed to be adjacent to the left instrument-panel side portion 20. Note that a downhill step (not shown) directed toward the top face side of the right instrument-panel side portion 20 is formed between the top face of the instrument-panel body portion 12 and the top face (surface) of the right instrument-panel side portion 20. Further, in the present embodiment, as illustrated in FIG. 13, a downhill step G3 directed toward the top face side of the instrument-panel under-window portion 16 is formed between the top face of the instrument-panel body portion 12 and the top face (surface) of the instrument-panel under-window portion 16. Note that, in FIG. 13, WS indicates the front windshield. This embodiment has a configuration similar to that of the first embodiment except the above configuration.

Similarly to the first embodiment, in the present embodiment, the components can be commonized, and the degree of freedom in setting of the wheel position can be improved. Besides, in the present embodiment, the steps G1, G2, G3 and the steps (not shown) are formed. Accordingly, a boundary B1 between the top face of the instrument-panel body portion 12 and the top face of the spacer 14, a boundary B2 between the top face of the spacer 14 and the top face of the instrument-panel side portion 20, a boundary B3 between the top face of the instrument-panel body portion 12 and the top face of the instrument-panel under-window portion 16, and a boundary between the top face of the instrument-panel body portion 12 and the top face of the instrument-panel side portion 20 are hardly observed from a driver D (see FIG. 11) who operates the wheel 24. As a result, the outward appearance of the instrument panel 90 seen from the driver D can be improved. Note that, in FIG. 11, arrows E1, E2 indicate directions of the sightline of the driver D.

The present disclosure has been described with reference to some embodiments, but the present disclosure can be performed with various modifications without departing from the gist of the present disclosure. Further, it is needless to say that the scope of the present disclosure is not limited to each of the above embodiments.

What is claimed is:

1. An instrument panel structure comprising:
an instrument-panel body portion constituting a body portion of an instrument panel of a vehicle and placed in front of a wheel in a vehicle front-rear direction; and
one or more spacers configured to be placeable selectively on a first side or a second side in a vehicle width direction relative to the instrument-panel body portion, the one or more spacers constituting part of the instrument panel.

2. The instrument panel structure according to claim 1, wherein only one spacer is provided.

3. The instrument panel structure according to claim 2, wherein:
in a state where the spacer is placed on the first side in the vehicle width direction relative to the instrument-panel body portion, the wheel is placed in a center in the vehicle width direction; and
in a state where the spacer is placed on the second side in the vehicle width direction relative to the instrument-panel body portion, the wheel is placed by being displaced to the first side in the vehicle width direction from the center in the vehicle width direction.

4. The instrument panel structure according to claim 1, wherein two spacers are provided.

5. The instrument panel structure according to claim 4, wherein:
in a state where the two spacers are separately placed on the first side and on the second side in the vehicle width direction relative to the instrument-panel body portion, the wheel is placed in a center in the vehicle width direction; and
in a state where the two spacers are placed on either one of the first side and the second side in the vehicle width direction relative to the instrument-panel body portion, the wheel is placed by being displaced to the other one of the first side and the second side from the center in the vehicle width direction.

6. The instrument panel structure according to claim 1, further comprising an instrument-panel under-window portion provided with a defroster air outlet, the instrument-panel under-window portion being adjacently placed in front of the instrument-panel body portion and the spacer in the vehicle front-rear direction.

7. The instrument panel structure according to claim 1, further comprising a pair of right and left instrument-panel side portions provided such that the right and left instrument-panel side portions are placed in opposite side portions of a vehicle cabin in the vehicle width direction, wherein the instrument-panel body portion and the spacer are placed between the instrument-panel side portions.

8. The instrument panel structure according to claim 1, wherein a downhill step directed toward a surface side of the spacer is formed between a surface of the instrument-panel body portion and a surface of the spacer.

9. The instrument panel structure according to claim 6, wherein a downhill step directed toward a surface side of the instrument-panel under-window portion is formed between a surface of the instrument-panel body portion and a surface of the instrument-panel under-window portion.

10. The instrument panel structure according to claim 7, wherein a downhill step directed toward a surface side of the instrument-panel side portion is formed between a surface of the instrument-panel side portion and a surface of the instrument-panel body portion or the spacer placed to be adjacent to the instrument-panel side portion.
